(19) United States
(12) Patent Application Publication
(10) Pub. No.: US 2022/0375162 A1
(43) Pub. Date: Nov. 24, 2022

(54) Systems and Methods for Generating and Applying Depth Keys at Individual Point Cloud Data Points

(71) Applicant: Illuscio, Inc., Culver City, CA (US)

(72) Inventors: Robert Monaghan, Ventura, CA (US); Joseph Bogacz, Perth (CA)

(73) Assignee: Illuscio, Inc., Culver City, CA (US)

(21) Appl. No.: 17/326,638

(22) Filed: May 21, 2021

(51) Int. Cl. G06T 17/10; G06T 7/73; G06T 19/00; G06T 15/08; G06T 7/55

(52) U.S. Cl. CPC G06T 17/10; G06T 7/73; G06T 19/00; G06T 15/08; G06T 7/55; G06T 2207/10028

(57) ABSTRACT

Disclosed is an imaging system that use point cloud data point depth values and/or positional data to accurately differentiate and extract features from a point cloud representation of a three-dimensional (“3D”) environment without loss of extremely fine details of the extracted features, and without reliance on green screens or other chroma keying techniques. The imaging system differentiate and extract a set of data points, that represent a particular feature in the 3D environment, from other data points of a first point cloud based on the positional data of the set of data points being within depth values specified for feature extraction. The imaging system may generate the 3D environment with at least one visual effect by inserting the set of data points into a second point cloud with one or more data points of the second point cloud differing from the data points of the first point cloud.

### BACKGROUND

Chroma key compositing, or chroma keying, may use color to differentiate objects within a foreground from a uniformly colored background, and to separately extract and/or edit the objects. Green screens are an application of chroma keying.

Chroma keying is, however, limited in the level of detail it may extract and/or differentiate. The detail associated with individual strands of hair, jagged or textured outlines or edges, and/or surfaces that are thin or have subtle deviations may be lost with chroma keying if those hair strands, outlines, edges, and/or surfaces blur together with the background and/or cannot be differentiated from the background because of their thickness, resolution, or size in the captured images. The loss of detail may reduce the realism or degrade the quality of visual effects resulting from inserting, replacing, or otherwise editing the extracted objects separate from other objects, background, or elements in a composite image.

### BRIEF DESCRIPTION OF THE DRAWINGS

FIG. 1 illustrates an example of coalescing descriptive characteristics and positional data for different surfaces, features, and/or points of a three-dimensional (“3D”) environment into a plurality of data points of a point cloud in accordance with some embodiments presented herein.

FIG. 2 presents a process for point cloud depth-based feature extraction in accordance with some embodiments presented herein.

FIG. 3 illustrates an example of the point cloud depth-based feature extraction in accordance with some embodiments presented herein.

FIG. 4 illustrates an example of using depth-based and descriptive characteristic-based feature extraction to differentiate and extract non-uniformly colored features and/or objects anywhere within a 3D environment in accordance with some embodiments presented herein.

FIG. 5 presents a process for setting a position of an extracted object within a point cloud in accordance with some embodiments.

FIG. 6 presents a process for consistent feature extraction across different point clouds based on a combination of depth-based and descriptive characteristic-based feature extraction in accordance with some embodiments presented herein.

FIG. 7 illustrates an example of assistive point cloud processing in accordance with some embodiments presented herein.

FIG. 8 illustrates an example of generating measurements based on the positional data of different point cloud data points in accordance with some embodiments presented herein.

FIG. 9 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Provided are systems and methods for generating and using depth values at individual point cloud data points for detailed three-dimensional (“3D”) image and/or video processing. The systems and methods may include a point cloud imaging system that captures visual and non-visual descriptive characteristics of a three-dimensional (“3D”) environment, that uses Light Detection and Ranging (“LiDAR”), structured light, and/or other depth detecting technologies and/or sensors to map the 3D positioning of each detected feature, surface, and/or other point of the 3D environment, and that populates a point cloud with a plurality of data points based on a coalescing of the descriptive characteristics and the positional data obtained from the 3D environment.

In some embodiments, the imaging system may use the LiDAR, structured light, and/or other depth detecting technologies and/or sensors to measure and record the depth and 3D positioning of each detected feature, surface, and/or other point with millimeter precision in the resulting point cloud. In some embodiments, the imaging system may use a first camera or sensor to capture the descriptive characteristics with a first set of positional data or with two-dimensional (“2D”) positional data, and may use a second camera or sensor (e.g., the LiDAR, structured light, and/or other depth detecting technologies and/or sensors) to add depth values and/or 3D positional data that enhances, supplements, or otherwise more accurately positions the descriptive characteristics obtained from the first camera or sensor in the 3D space of the point cloud so that the point cloud data points mirror the minute detail within the 3D environment with exact positioning. In some embodiments, the imaging system may alternate between capturing the descriptive characteristics of the 3D environment and performing the depth detection to accurately map the captured descriptive characteristics as point cloud data points positioned in a representative 3D space.

The imaging system may use the depth values and/or positional data to accurately differentiate and extract features and/or objects from the point cloud without loss of extremely fine details of the extracted features and/or objects, and without reliance on green screens or other chroma keying techniques. Specifically, the imaging system may extract the entire set of data points that represent a particular feature within the point cloud and may retain and/or preserve, during the extraction, the subsets of the set of point cloud data points that represent individual strands of hair, jagged or textured outlines or edges, and/or surfaces of the extracted feature and/or object that are thin or have subtle deviations as these parts of the particular feature are differentiated from other elements (e.g., the background) by virtue of the assigned depth values.

Accordingly, the imaging system may use the depth values as a substitute for chroma keying, and may allow for feature and/or object extraction even when a green screen or chroma keyed background is not used. Moreover, the feature and/or object extraction performed by the imaging system set forth herein may be more accurate relative to green screen and/or chroma keying techniques because the imaging system is able to preserve the minute detail in the extracted features and/or objects that is often lost when the details are so small, thin, blend, and/or are otherwise indistinguishable from the green screen or chroma keyed background regardless of the image or camera resolution used to capture the 3D environment.

The objects and/or features extracted by the imaging system may be used to create the same visual effects that are currently created with chroma keying. For instance, the extracted objects and/or features may be digitally reinserted into point clouds of other 3D environments or scenes (e.g., replace the background or other objects from original 3D environment), edited apart from other objects or visual elements of the original 3D environment, inserted into 2D images or scenes, and/or may be affected by introduced objects, new backgrounds, and/or other visual effects that were not present in the original 3D environment.

In some embodiments, the imaging system may use the depth values in conjunction with the descriptive characteristics of the point cloud data points to track movement of a particular object across different frames of video and/or different states of a 3D environment, and to extract the same detail for the particular object across the different frames or states. For instance, the depth values for the data points forming a particular strand of hair may vary significantly from frame to frame, but the descriptive characteristics representing the color of the particular strand of hair will remain mostly the same. Accordingly, once the imaging system isolates the particular strand of hair in a first frame represented by a first point cloud using the data point depth values, the imaging system may continue to isolate and extract that same particular strand of hair from subsequent frames represented by other point clouds based on a combination of the depth values, coloring data, and/or other descriptive characteristics of the point cloud data points forming that particular strand of hair.

In addition to visual effects processing, the point cloud data point depth values may be used for scientific, cartography, engineering, and/or other applications. For instance, a user may interact with a point cloud to view a 3D environment from one or more perspectives, and/or may select different data points within the point cloud to obtain a precise measurement of the distance separating the selected data points. The distances between different positions within the 3D environment may be computed directly from the positional data of the point cloud data points at the different positions. Moreover, the measurements obtained from the point cloud data points may allow users to obtain measurements from locations that are physically inaccessible in the actual 3D environment. For instance, the imaging system allows for users to select data points that are within walls, solid structures, and/or enclosed or inaccessible spaces, and the imaging system may still produce accurate measurements to and from those data points.

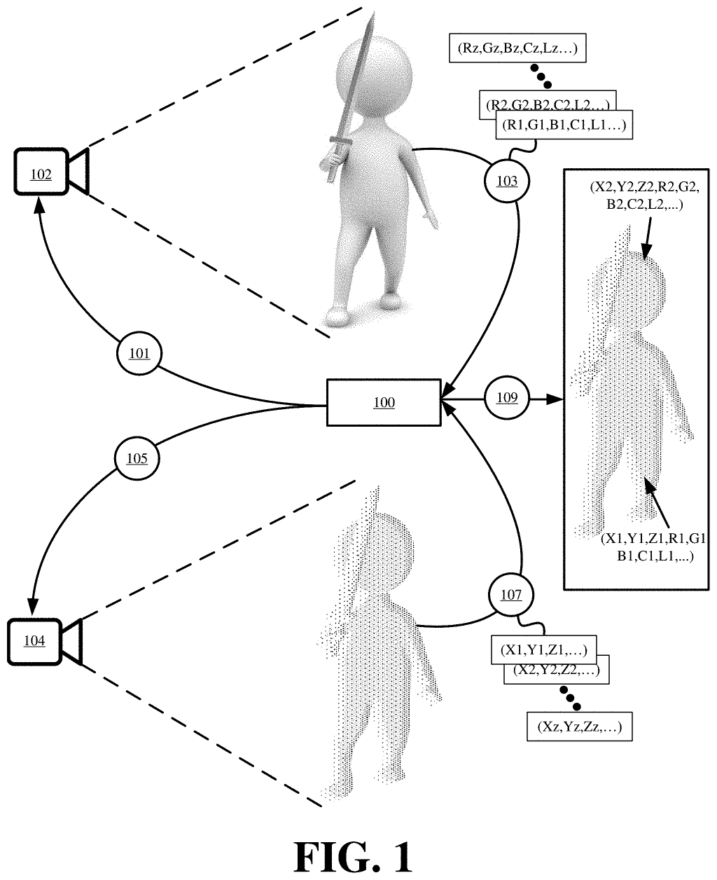

FIG. 1 illustrates an example of coalescing descriptive characteristics and positional data for different surfaces, features, and/or points of a 3D environment into a plurality of data points of a point cloud in accordance with some embodiments presented herein. In particular, FIG. 1 illustrates imaging system 100 coalescing output from at least first sensor 102 and second sensor 104 to generate a point cloud that accurately maps descriptive characteristics from the surfaces, features, and/or points of the 3D environment to point cloud data points that are defined in 3D space to mirror the positioning of the surfaces, features, and/or points of the 3D environment.

First sensor 102 may correspond to an imaging sensor and/or device such as a Charge-Coupled Device (“CCD”) sensor or Complementary Metal-Oxide-Semiconductor (“CMOS”) sensor. Imaging system 100 may activate (at 101) first sensor 102 to capture (at 103) descriptive characteristics of the 3D environment. The descriptive characteristics may include visual characteristics of the 3D environment such as the colors, chrominance, luminance, and/or visible properties across the surfaces, features, and/or other points within the 3D environment. The descriptive characteristics may also include non-visual characteristics of the 3D environment such as temperatures, magnetic properties, density, and/or other non-visible properties across the surfaces, features, and/or other points within the 3D environment. In some embodiments, first sensor 102 may generate one or more 2D images that capture the descriptive properties of the 3D environment.

Second sensor 104 may include a 3D or depth-sensing camera, LiDAR, Magnetic Resonance Imaging (“MRI”) device, Positron Emission Tomography (“PET”) scanning device, Computerized Tomography (“CT”) scanning device, time-of-flight device, and/or other depth detecting technologies and/or sensors. Accordingly, second sensor 104 may use lasers, sound, radio waves, visible light patterns, non-visible light patterns (e.g., infrared light), magnetic fields, and/or other signaling to detect and measure subtle and/or microscopic variations in the shape, form, and/or positioning across various surfaces, features, and/or other points in the 3D environment.

Second sensor 104 may be positioned at the same or similar position as first sensor 102, and imaging system 100 may activate (at 105) second sensor 104 to granularly map (at 107) detected details of each surface, feature, and/or other point of the 3D environment to a plurality of point cloud data points positioned within 3D space of a point cloud. In particular, second sensor 104 may measure the position of each detected surface, feature, and/or point of the 3D environment, and may generate a data point at a position in the point cloud that corresponds to the measured position of the detected surface, feature, or other point.

In some embodiments, first sensor 102 and second sensor 104 may be rotated around the 3D environment to perform a 360-degree capture of the 3D environment. In some other embodiments, imaging system 100 may have multiple first sensors 102 and second sensor 104 distributed throughout the 3D environment to perform the 360-degree capture of the 3D environment.

In some embodiments, second sensor 104 may be integrated or embedded as part of first sensor 102. For instance, the combined sensor may include photosites that each capture red, green, blue (“RGB”) color information and depth information via infrared and/or other non-visible light measurements.

In any case, imaging system 100 may combine the outputs of first sensor 102 and second sensor 104 to generate a point cloud representation of the 3D environment. In particular, imaging system 100 may map (at 109) the descriptive characteristics obtained from imaging the 3D environment with first sensor 102 to individual data points that are generated from the depth-based scanning of the 3D environment with second sensor 104.

The mapping (at 109) may be based on a correspondence between the position of each data point in the 3D space and the location at which the descriptive characteristics were captured within the 3D environment. In some embodiments, imaging system 100 may map (at 109) descriptive characteristics from pixels of a 2D image generated by first sensor 102 to the data points that are plotted in 3D space for the detected surfaces, features, and/or other points of the 3D environment by second sensor 104. In some such embodiments, the image output from first sensor 102 may inherently or explicitly define x-coordinate and y-coordinate values for the captured descriptive characteristics, but may omit a z-coordinate value or depth value. Imaging system 100 may add the descriptive characteristic data at each x-y coordinate pair to the depth value of data points having the same x-y coordinate pair. In some embodiments, the mapping (at 109) may include generating a 3D representation based on the descriptive characteristics, and wrapping or otherwise applying the descriptive characteristics to the data points positioned in the 3D space.

As a result of the mapping (at 109), each data point of the point cloud may include positional data, such as an x-coordinate, y-coordinate, and z-coordinate position, and may include descriptive characteristics. In other words, each data point may include an array of data elements that store the positional data and the descriptive characteristics. The descriptive characteristic data elements may include colors of a feature, surface, and/or other point at a position in the 3D environment that maps directly to the position of that particular data point in the point cloud. The color characteristics may be represented using RGB and/or other values. In some embodiments, the descriptive characteristics may also include chrominance and/or luminance values. The descriptive characteristics may also include non-visual characteristics of the 3D environment. For instance, the non-visual characteristics may include a Tesla strength value that quantifies the strength of a magnetic field that was used in detecting and/or imaging the surface, features, and/or other points of the 3D environment. The non-visual characteristics may also measure and/or record energy, sound, and/or other non-visual properties of the detected surfaces, features, and/or other points of the 3D environment.

Consequently, the resulting data points of the generated point cloud may differ from pixels of any 2D image because certain regions of the point cloud may have no data points, lower densities of data points, higher densities of data points, and/or data points at different depths based on varying amounts of visual information that is detected at those regions. In contrast, pixels of a 2D image have a uniform density and fixed 2D arrangement that is defined by the resolution of the 2D image. Moreover, the point cloud data points may have a non-uniform placement or positioning, whereas the 2D image has pixel data for each pixel of a defined resolution (e.g., 640×480, 800×600, etc.).

Imaging system 100 may also be used to generate multiple point clouds that capture a changing state of a 3D environment over time. Accordingly, the multiple point clouds may correspond to different frames of video. Capturing the changing state of the 3D environment may include generating each point cloud with a different number of data points to represent changing surfaces, features, and/or points in the 3D environment, data points at different position to capture movement of the surfaces, features, and/or points over time, and/or different descriptive characteristics to capture changing coloring, lighting, and/or other visual or non-visual characteristics across the surfaces, features, and/or points.

In order to separately capture the descriptive characteristics and positional data of a changing 3D environment, imaging system 100 may periodically switch between activations of first sensor 102 and second sensor 104. For instance, to generate a 30 frames-per-second (“fps”) video of the changing 3D environment, imaging system 100 may operate first sensor 102 and second sensor 104 at 60 fps, and may switch between activations of first sensor 102 and second sensor 104 every 5 frames, 10 frames, 15 frames, etc. In some embodiments, first sensor 102 may be activated for a longer duration than second sensor 104 (e.g., activate first sensor 102 for 10 frames and second sensor 104 for 5 frames) or vice versa depending on the time needed for each sensor 102 and 104 to capture, measure, and/or record the corresponding data. For instance, second sensor 104 may use a structured light pattern to measure depth and capture the positional data for the point cloud data points. Second sensor 104 may require at least 10 milliseconds (“ms”) to illuminate the 3D environment with the structured light pattern and another 5 ms to obtain one or more depth measurements of the 3D environment. The time for detecting the surfaces of the 3D environment and plotting those surfaces as data points in a point cloud may therefore take longer than the time for obtaining images with the descriptive characteristics of the 3D environment. Imaging system 100 may then combine and/or coalesce the descriptive characteristics that were obtained for a particular state of the 3D environment (e.g., frames 1-5 captured with first sensor 102) with the positional data that is generated by second sensor 104 (e.g., frames 6-15) at or nearest to the time the descriptive characteristics were captured.

In some other embodiments, second sensor 104 may be activated at the same time as first sensor 102 such that first sensor 102 continually captures the descriptive characteristics of the 3D environment at the same time and/or rate at which second sensor 104 obtains the positional data for the point cloud data points. For instance, LiDAR may have no effect on imaging of the 3D environment. Accordingly, the LiDAR may be activated to obtain depth measurements at the same time at which first sensor 102 obtains images for the descriptive characteristics of the 3D environment. Similarly, second sensor 104 may use infrared light to illuminate the 3D environment with a non-visible structured light pattern that does not impact the capture of the descriptive characteristics by first sensor 102. Accordingly, second sensor 104 may obtain the positional data and may generate the point cloud data points based on depth values measured using the non-visible structured light pattern at the same time at which the descriptive characteristics are captured using the first sensor 102.

In some embodiments, imaging system 100 may use the positional data and/or the depth information from the resulting point clouds to accurately extract 3D features and/or objects from the 3D environment for visual effects, video editing, and/or image processing applications. Specifically, imaging system 100 may use the positional data and/or the depth information as a substitute for chroma keying, and may perform an extraction of a desired object from the 3D environment that is more accurate and that captures more detail than traditional chroma keying techniques without the use of a green screen or chroma keyed background.

The point cloud-based feature extraction set forth herein based on the positional data and/or the depth information may preserve fine detail of the extracted object that is otherwise lost with chroma keyed feature extraction. For instance, fine hairs that extend off an actor's head or face (e.g., beard hairs) may be indistinguishable from a chroma keyed background and would be lost with chroma keyed feature extraction, but would be preserved and retained by the point cloud-based feature extraction set forth herein.

Imaging system 100 may also provide greater control over the feature extraction by selecting specific depth values at which to extract one or more features or to differentiate the one or more features from other features or background imagery. For instance, chroma keying may involve removing everything in the background that matches the chroma key. Conversely, imaging system 100 may extract different features at different depths of the point cloud, thereby allowing some foreground and background features to be extracted or retained while other foreground and background features may be removed.

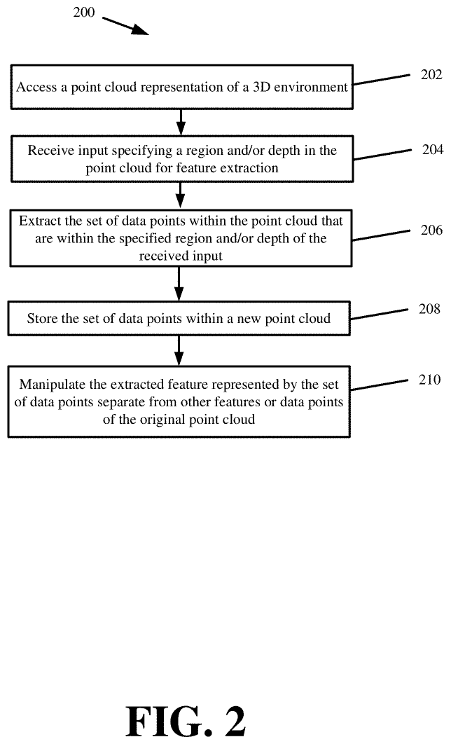

FIG. 2 presents a process 200 for point cloud depth-based feature extraction in accordance with some embodiments presented herein. Process 200 may be implemented by imaging system 100.

Process 200 may include accessing (at 202) a point cloud representation of a 3D environment. Accessing (at 202) the point cloud representation may include opening, retrieving, and/or obtaining the point cloud representation from a file, database, or other source. The point cloud representation may be generated using the techniques described above with reference to FIG. 1, and may include a plurality of data points that are non-uniformly positioned in 3D space, and each data point having positional data that define the positioning of that data point in the 3D space, and descriptive characteristics that define how that data point is to be rendered or presented in generating a 3D image of the 3D environment.

Process 200 may include receiving (at 204) input specifying a region and/or depth in the point cloud for feature extraction. In some embodiments, imaging system 100 may render the point cloud representation of the 3D environment on a display based on the positional data and the descriptive characteristics of the point cloud data points. A user may move within the rendered 3D environment, and may make one or more selections that are linked to one or more of the data points at the desired depth for the feature extraction. For instance, the user may select the frontmost data point of a desired object and the backmost data point of the desired object, and imaging system 100 may automatically determine the maximum and minimum depth values at which to perform the extraction based on the user selection. Additionally, or alternatively, the user may select a region or volume of data points at which the feature extraction is to be performed. In some other embodiments, the input may include values for the minimum depth and the maximum depth at which imaging system 100 is to perform the feature extraction (e.g., extract any features between a first z-coordinate value and a second z-coordinate value). The user may restrict the feature extraction to a specific region by additionally providing minimum and maximum x-coordinate and/or y-coordinate at which the feature extraction at the specified depths is to occur. In some embodiments, the user input may be specified as a vector and/or with angles to adjust the extraction depth value at different locations within the point cloud. For instance, the desired object for extraction may extend forward at the top and may extend backward at the bottom. In this case, the user input may specify a smaller or closer z-depth value for extracting data points at a region of the point cloud corresponding to the top of the desired object, and may specify a larger or farther z-depth value for extracting data points at a region of the point cloud corresponding to the bottom of the desired object.

Process 200 may include extracting (at 206) the set of data points within the point cloud that are within the specified region and/or depth of the received (at 204) input. Extracting (at 206) the set of data points may include locating, sorting, and/or filtering the plurality of data points that form the point cloud to isolate the smaller set of data points having positional data matching or satisfying the positioning at the specified region and/or depth of the received (at 204) input. For instance, the input may specify a depth range at which a particular actor appears in the point cloud (e.g., a first z-coordinate value and a second z-coordinate value), and imaging system 100 may isolate the set of data points in that depth range that represent all features, observable points, and/or other parts of the actor (e.g., the set of data points with z-coordinate values in between the first z-coordinate value and the second z-coordinate value). Since the extraction (at 206) is based on the depth information contained within the point cloud data points, and not within coloring data appearing within an image, imaging system 100 is able to extract the particular actor with more detail than when using chroma-keying techniques as individual strands of hair, edges, outlines, and/or parts of the particular actor, that may otherwise blend with the background coloring, may be differentiated and retained within the extracted (at 206) set of data points by virtue of the depth information captured for those parts.

Process 200 may include storing (at 208) the set of data points within a new point cloud, 3D environment, 2D image, or 2D environment, and/or may include editing, adjusting, and/or otherwise manipulating (at 210) the extracted feature represented by the set of data points separate from other features or data points of the original point cloud. In some embodiments, the manipulation (at 210) may include digitally inserting a new background or objects into the new point cloud at desired depths relative to the set of data points of the extracted feature. In this manner, imaging system 100 may provide green screen or chroma key effects without the use of a green screen or chroma keyed background, and without exclusively relying on coloring information to differentiate one feature from other features or a background. In some other embodiments, the manipulation (at 210) may include digitally inserting the set of data points as a 2D rendered object within a 2D image or 2D scene, wherein digitally inserting the set of data points may include flattening the data points or retaining the frontmost data points, rendering the 2D object or 2D feature that is represented by the flattened or retained data points, resizing the rendered object or feature according to the placement of the object or feature within the 2D image or 2D scene, and/or adjusting the lighting of the digitally inserted object to match the lighting of the 2D image or 2D scene.

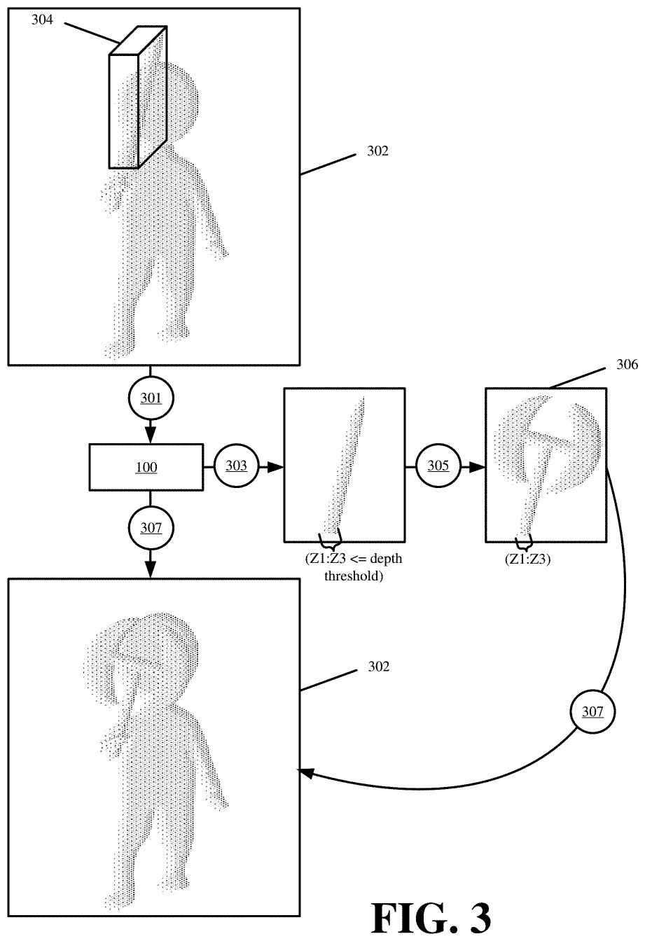

FIG. 3 illustrates an example of the point cloud depth-based feature extraction in accordance with some embodiments presented herein. The figure includes point cloud 302 representing a 3D environment with an actor holding a sword. Point cloud 302 may be defined with a plurality of data points that have positional data and descriptive characteristics mapped from detected features, surfaces, and/or other objects of the 3D environment.

Imaging system 100 may receive (at 301) volume 304 as input. Volume 304 may specify minimum and maximum depth values (e.g., z-coordinate values) at which to perform the feature extraction, and may specify a region within point cloud 302 to perform the feature extraction (e.g., minimum and maximum x-coordinate and y-coordinate values subject to extraction).

Imaging system 100 may extract (at 303) a first set of data points that satisfy the depth value range and/or that are within the volume defined by the user input. In this example, the first set of data points may correspond to the sword blade that is in front of the actor's body, and therefore distinguishable from the actor's body and/or other objects in the 3D environment based on the depth values.

The first set of data points may be edited (at 305) separately from other data points of point cloud 302 as a result of the extraction (at 303). As shown in FIG. 3, the editing (at 305) may include replacing the first set of data points representing the sword blade with second set of data points 306 representing an axe blade. Second set of data points 306 may have the same depth values as the first set of data points, but may include more or differently placed data points about the x and/or y coordinate planes. In some embodiments, the editing (at 305) may further include adjusting the visual characteristics and/or lighting of second set of data points 306 to match the coloring and lighting of point cloud 302. The editing (at 305) may further include sizing and/or orienting second set of data points 306 to match the sizing and/or orientation of the extracted (at 303) first set of data points.

Imaging system 100 may insert (at 307) second set of data points 306 into point cloud 302 in place of the extracted first set of data points. In doing so, imaging system 100 may produce a visual effect that replaces the original object that was physically held by actor with another object without the use of green screens or chroma keying. Moreover, the selection and replacement of the original object (e.g., sword blade) was primarily based on the depth values of the point cloud data points, and did not involve the user manually selecting or outlining the data points representing the entirety of the sword blade or the user holding a uniformly colored object that could be extracted via green screen or chroma keying techniques.

Imaging system 100 may generate 3D or 2D images from point cloud 302 after inserting (at 307) second set of data points 306 into point cloud 302. The generated images may include frames within an animation or video, a scene within a digitally constructed 3D or 2D application, game, and/or other environment, and/or may include edited images for other purposes. The generated images may include textured or continuous surfaces, objects, and/or features that are rendered from second set of data points 306 and other data points of point cloud 302, or may include a direct visualization of the point cloud data points after the editing (at 305), wherein the data points may be densely packed to correspond to individual pixels on a display or may appear as continuous surfaces, objects, and/or features.

In some instances, a point cloud may contain data points for different objects at the same depth plane. In such instances, the depth-based feature extraction, although accurate, may extract data points for undesired objects. For instance, the data points for the actor's hand have the same depth values as the data points for the sword hilt or other parts of the sword, which may cause the depth-based extraction to include the actor's hand when attempting to extract just the sword.

Accordingly, in some embodiments, imaging system 100 may improve the feature extraction accuracy by using the descriptive characteristics with the positional data to better differentiate between the set of data points that are part of the same feature subject to extraction and other neighboring data points that are part of the background or other features that are not subject to extraction. Specifically, in selecting neighboring data points for extraction as part of a desired feature, imaging system 100 may compare the depth values of the neighboring data points to determine that those depth values are within a threshold of the depth value of an already selected data point of the desired feature, and may also compare the descriptive characteristics of the same neighboring data points to determine that the values for those descriptive characteristics also within thresholds of the descriptive characteristic values of an already selected data point of the desired feature. As a result, imaging system 100 may improve the feature extraction accuracy by determining the set of data points that represent a feature that is subject to extraction based on the set of data points having depth value continuity and descriptive characteristic continuity. If a particular data point has depth continuity, but has entirely different coloring than an already selected data point for a feature selected for extraction, then imaging system 100 may exclude the particular data point from being included as part of the set of data points forming the feature selected for extraction.

In some embodiments, imaging system 100 may use artificial intelligence and/or machine learning (“AI/ML”) to determine if there is depth value continuity and/or descriptive characteristic continuity between neighboring data points. The AI/ML may replace the thresholds with predictive models of expected depth changes and/or descriptive characteristic changes for neighboring data of different features being extracted from a point cloud. For instance, in extracting a tree from a point cloud, the AI/ML may allow for neighboring data points to have descriptive characteristic variations to account for tree branches having brown coloring and the leaves of the tree branches having green coloring, and to include these neighboring data points as part of the same extracted feature despite the change in the descriptive characteristics of the neighboring data points not satisfying a threshold.

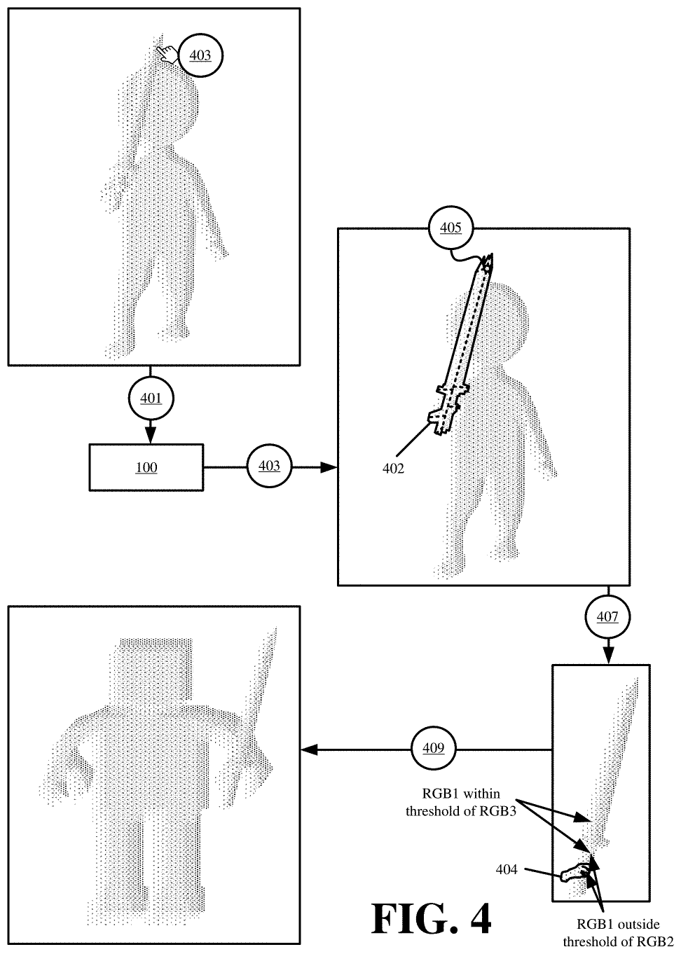

FIG. 4 illustrates an example of using depth-based and descriptive characteristic-based feature extraction to differentiate and extract non-uniformly colored features and/or objects anywhere within a 3D environment in accordance with some embodiments presented herein. As shown in FIG. 4, the point cloud representation of the 3D environment may present an actor holding a particular non-uniformly colored object (e.g., sword) in his hand, and imaging system 100 may be tasked with automatically selecting and extracting the data points forming the particular non-uniformly colored object without including data points of the actor's hand grasping the object and/or other data points forming other objects or features, and imaging system 100 may perform the selection and extraction using depth values and descriptive characteristics of the point cloud data points. In this example, chroma keying could not be used to differentiate and/or extract the object from the actor's hand due to the color non-uniformity in the 3D environment.

Imaging system 100 may receive and/or generate (at 401) the point cloud representation of the 3D environment, and may receive (at 403) user input for the depth value or depth range at which to perform the object and/or feature extraction. In some embodiments, the user input may include selection of one data point of the particular object. Imaging system 100 may determine the depth value or depth range for the feature extraction by determining the depth value of the selected data point. In other words, the user may click on any one data point of the sword in the point cloud, and imaging system 100 may automatically proceed to identify and extract all the data points that form the sword in the point cloud while excluding data points of other features or objects (e.g., the actor's hand grasping the sword). In some embodiments, the user input may include one or more depth values (e.g., a depth range) that are input by the user and that encompass one or more data points of the particular object.

Imaging system 100 may select (at 405) first set of data points 402 from the point cloud based on the user input and the positional data and/or depth values of the point cloud data points. The selection of first set of data points 402 may include isolating a first data point that is selected by the user or that has a depth value in the specified range of depth values, extending outward from the first data point to neighboring data points, and selecting a subset of the neighboring data points to include in first set of data points 402 based on depth continuity between the first data point and the subset of neighboring data points. Specifically, imaging system 100 may include a neighboring data point in first set of data points 402 when the depth value of the neighboring data point is within a threshold range of the first data point depth value. Imaging system 100 may then continue the outward selection by comparing the depth value of a second data point from the selected subset of neighboring data points to the depth value of neighboring data points of the second data point until no new neighboring data points are added to first set of data points 402 because of a lack of depth continuity between a selected data point and its neighboring data points.

As shown in FIG. 4, first set of data points 402 may include data points that have positional data and/or depth values in a specific range, and exclude other data points of the point cloud with position data and/or depth values outside the specific range. More specifically, first set of data points 402 may include the data points forming the sword held in front of the actor, and also various data points of the actor's hand that are also positioned in front of the actor, used to hold the sword, and are therefore within the specified user input depth value range.

Imaging system 100 may filter (at 407) first set of data points 402 based on descriptive characteristic continuity. The filtering (at 407) may include determining the descriptive characteristics of the first data point selected by the user or descriptive characteristic commonality across first set of data points 402, and generating a second set of data points to add or retain data points having descriptive characteristic commonality with neighboring data points of first set of data points 402 and to exclude data points of first set of data points 402 from the second set of data points that do not have the descriptive characteristic commonality with the neighboring data points of first set of data points 402.

In some embodiments, the filtering (at 407) may be based on one or more thresholds. For instance, if neighboring data points in first set of data points 402 have RGB values that differ by less than a particular percentage, then the neighboring data points are retained as part of the second set of data points. However, if RGB values of a particular data point in first set of data points 402 differ by more than the particular percentage, then imaging system 100 may remove the particular data point from the second set of data points.

As shown in FIG. 4, the filtering (at 407) may include differentiating and excluding from the second set of data points, subset of data points 404 of the actor's hand that were included in first set of data points 402 because subset of data points 404 had depth continuity with other data points of first set of data points 402 forming the sword in the actor's hand. In particular, subset of data points 404 forming the actor's hand may have RGB, chrominance, luminance, density, and/or other descriptive characteristics that are not within specified thresholds of the RGB, chrominance, luminance, density, and/or other descriptive characteristics for the data points forming the sword, and may be removed from the second set of data points as a result.

In some embodiments, imaging system 100 may also compare descriptive characteristics of outlying data points that neighbor first set of data points 402 but that are not included as part of first set of data points 402 (e.g., have positional data within a certain distance from the edge or border data point of first set of data points 402), and if the descriptive characteristics of the outlying data points are within the threshold of the descriptive characteristics of the neighboring data points in first set of data points 402, then imaging system 100 may add the outlying data points to the second set of data points. The outlying data points may include additional details of the desired feature that were not included in first set of data points 402 because of depth discontinuity, but that are added to the second set of data points because of descriptive characteristic continuity. For instance, a reflection or lighting effect may extend out of range of the depth values for the data points of the sword, and may be added to the second set of data points by tracking the descriptive characteristic continuity for the reflection or lighting effect from one or more of first set of data points 402 to additional data points that are outside first set of data points 402.

In some embodiments, imaging system 100 may use AI/ML to perform the filtering (at 407). Imaging system 100 may use the AI/ML to generate a model of descriptive characteristics for the desired feature. The model may allow for certain descriptive characteristic discontinuity but not other discontinuity. For instance, a change from brown to green coloring in neighboring data points may satisfy descriptive characteristic continuity, but a change from brown to blue coloring in neighboring data points may not satisfy the descriptive characteristic continuity.

In FIG. 4, the AI/ML may scan the descriptive characteristics of all point cloud data points to determine that the actor has one set of descriptive characteristics (e.g., flesh tones, armor with a first amount of reflectivity, etc.), and that the sword has a different set of descriptive characteristics (e.g., metallic tones, a second amount of reflectivity, etc.). Imaging system 100 may apply the AI/ML derived models when filtering (at 407) first set of data points 402 to differentiate and remove subset of data points 404 that form the actor's hand from the second set of data points representing only the data points of the sword (e.g., desired object subject to extraction).

In some embodiments, the filtering (at 407) may be based on additional user input. The additional user input may include selecting one or more data points for the actor's hand, and imaging system 100 may remove any data points that extend from the actor's hand and that have visual characteristic continuity with the selected one or more data points of the actor's hand.

Imaging system 100 may adjust and/or edit (at 409) the second set of data points separate from other data points of the point cloud. The adjustments may include applying different visual effects to the second set of data points, changing descriptive characteristics of one or more of the data points, or changing the size and/or positioning of one of more of the data points. The editing may include replacing the second set of data points with data points for a different feature or object, or rendering the second set of data points in a new point cloud or image with a new background or other features and/or objects. As shown in FIG. 4, the second set of data points representing the extracted sword may be placed into the hand of a digitally created avatar or character, thereby replacing the original actor holding the sword in the original 3D environment. The digitally created avatar or character holding the extracted sword may then be inserted into frames of a video, scenes of a digitally created environment (e.g., a video game, virtual reality environment, etc.), and/or other 3D or 2D scenes or images.

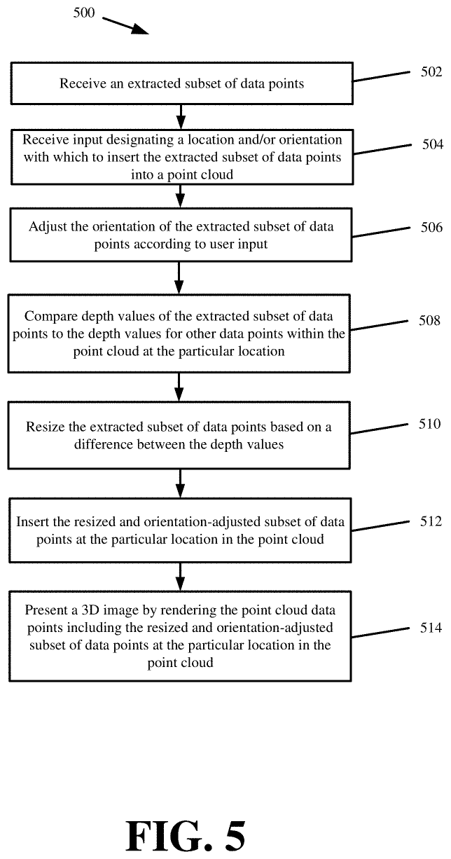

FIG. 5 presents a process 500 for setting a position of an extracted object within a point cloud in accordance with some embodiments. Process 500 may be implemented by imaging system 100.

Process 500 may include receiving (at 502) an extracted subset of data points. The subset of data points may be extracted from the same point cloud into which the subset of data points is to be repositioned. For instance, the subset of data points may represent a particular vehicle, and imaging system 100 may extract the subset of data points representing the particular vehicle from one location within the 3D environment represented by the entire point cloud, and reinserting the subset of data points with the proper size, dimensions, and/or orientation in another location within the 3D environment and/or point cloud. Alternatively, the subset of data points may be a digitally created object or object that is extracted from a first point cloud, and imaging system 100 may insert the subset of data points with the proper size, dimensions, and/or orientation at a location within a second point cloud.

Process 500 may include receiving (at 504) input designating a location and/or orientation with which to insert the extracted subset of data points into the point cloud. For instance, a user may rotate and/or zoom into a particular location within the 3D environment represented by the point cloud, and may define a desired orientation for the extracted subset of data points at the particular location.

Process 500 may include adjusting (at 506) the orientation of the extracted subset of data points according to user input. Adjusting (at 506) the orientation may include rotating, tilting, skewing, angling, and/or otherwise moving the extracted subset of data points to conform to the orientation specified by the user.

Process 500 may include comparing (at 508) the depth values of the extracted subset of data points to the depth values for other data points within the point cloud at the particular location selected for the insertion of the extracted subset of data points. The depth values may define the size of the data points or the size with which the data points are presented when rendering the point cloud from a particular point-of-view.

Process 500 may include resizing (at 510) the extracted subset of data points based on the comparison (at 508) a difference between the depth values. In particular, imaging system 100 may automatically scale the size at which the extracted subset of data points is rendered based on the difference between the depth values of the extracted subset of data points and point cloud data points at or around the particular location selected for insertion of the extracted subset of data points.

Process 500 may include inserting (at 512) the resized and orientation-adjusted subset of data points at the particular location in the point cloud. The user may perform additional adjustments to the lighting, shading, coloring, and/or other visual characteristics of the extracted subset of data points prior to or after the insertion (at 512) to more seamlessly integrate the subset of data points at the particular location in the point cloud.

Process 500 may include presenting (at 514) a 3D image or 2D image by rendering the point cloud data points including the resized and orientation-adjusted subset of data points at the particular location in the point cloud. In some embodiments, imaging system 100 may automatically reorient, resize, and insert the extracted subset of data points at the same particular location despite the particular location being at different position within different point clouds, wherein the different point clouds may represent different frames of video or different states of a particular 3D environment.

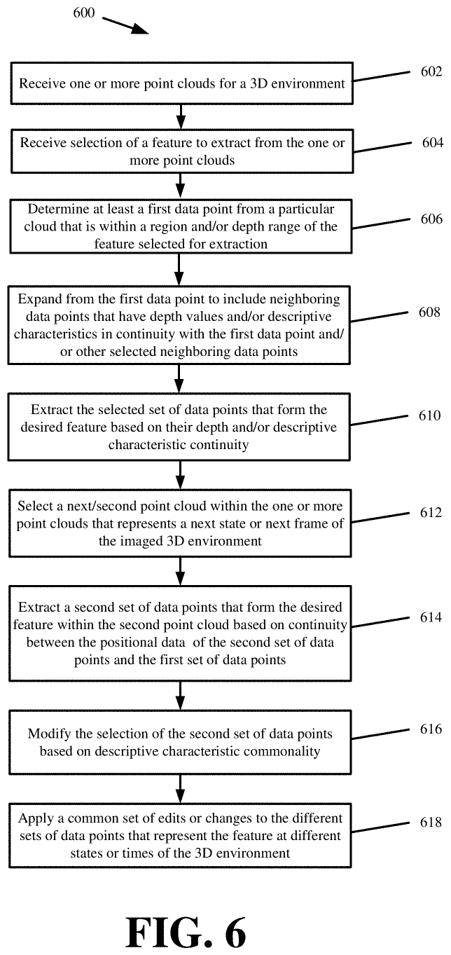

The depth-based and descriptive characteristic-based feature extraction may also be used for performing consistent feature extraction across different frames, states, or point clouds of a changing 3D environment even when the extracted feature moves out of the specified depth extraction range in one or more of the frames, states, or point clouds. FIG. 6 presents a process 600 for consistent feature extraction across different point clouds based on a combination of depth-based and descriptive characteristic-based feature extraction in accordance with some embodiments presented herein. Process 600 may be performed by imaging system 100.

Process 600 may include receiving (at 602) one or more point clouds that track changes in a 3D environment over time. The one or more point clouds may correspond to a point cloud video representation of the 3D environment. Each point cloud of the one or more point clouds may provide a different frame of video as a plurality of data points positioned within 3D space in a manner that recreates the state of the 3D environment captured by that frame of video.

Process 600 may include receiving (at 604) a selection of a feature to extract from a first point cloud of the one or more point clouds. In some embodiments, the selection may be based on user input that identifies a region and/or one or more depths within the first point cloud at which to perform the feature extraction. In some other embodiments, the selection may be based on user input that selects one or more data points of the desired feature from the first point cloud for extraction.

Process 600 may include determining (at 606) at least a first data point from the first cloud that is within the region and/or depth range of the feature selected for extraction. Process 600 may include expanding (at 608) from the first data point to include neighboring data points that have depth values and/or descriptive characteristics in continuity with the first data point and/or other selected neighboring data points.

Expanding (at 608) from the first data point may include selecting a first set of data points that represent the feature selected for extraction based on commonality in the depth values and descriptive characteristics between each subsets of neighboring data points. For instance, expanding (at 608) the selection to include neighboring data points with continuity in the depth values may include searching for neighboring data points in all directions that are no more than a specified distance from the first data point (e.g., neighboring data points falling within a volume centered on the first data point), and adding, to the selection of data points representing the feature for extraction, one or more neighboring data points that have a depth value that is within a threshold of the depth value of the first data point. Imaging system 100 may continue the outward search from each selected data point (e.g., each selected neighboring data point) to identify other data points that fall within the same or similar depth plane as the last selected neighboring data point. The outward search stops when a selected data point does not have any neighboring data points with depth values within the threshold of the depth value of the selected data point.

The expansion (at 608) and/or selection of data points that represent the desired feature selected for extraction is based on the understanding that the data points forming the desired feature, regardless of the shape of the desired feature, will have progressive changes in their depth values that differentiate the data points of the desired feature from the background or other features. For example, any continuous feature or object may have a data point with a z-coordinate value that does not deviate by a value of more than two from a neighboring data point of the same feature or object. If a particular data point has a z-coordinate value that deviates by a value of three or more from a neighboring data point of the desired feature or object, then imaging system 100 may determine that the particular data point is part of a different object that lacks depth continuity with and/or is too separated from the desired feature or object. The threshold value for determining the continuity in depth values of neighboring data points may be based on the accuracy, resolution, and/or measurement precision of the LiDAR, structured light, and/or other depth detecting technologies and/or sensors that generate the positional data for the point cloud data points.

Expanding (at 608) the selection to include neighboring data points with continuity in the descriptive characteristics involves a similar approach. In this case, imaging system 100 may search for neighboring data points in all directions that are no more than the specified distance from the selected first data point of the desired feature, and may add the subset of neighboring data points that have descriptive characteristic data elements (e.g., RGB values, chrominance values, luminance values, Tesla values, etc.) within a threshold of the descriptive characteristic data elements of the selected first data point. Imaging system 100 may continue the outward search to identify other data points that have similar coloring, luminance, chrominance, and/or other descriptive characteristics as a closest selected neighboring data point, and to exclude other neighboring data points with coloring, luminance, chrominance, and/or other descriptive characteristics that are not within the threshold of the descriptive characteristics for the closest selected neighboring data point.

In some embodiments, expanding (at 608) the selection for positional data and/or descriptive characteristic continuity may be performed using AI/ML. The AI/ML may dynamically determine a first set of acceptable variances or ranges in the positional data and/or descriptive characteristics between neighboring data points of the feature being extracted, and a second set of unacceptable variances or ranges in the positional data and/or descriptive characteristics between neighboring data points of the feature being extracted. In particular, the AI/ML may analyze the positional data and/or descriptive characteristics of the point cloud data points to determine patterns for different features and/or objects within the point cloud, and may derive the first set of acceptable variances or ranges from the determined patterns.

Process 600 may include extracting (at 610) the selected first set of data points that form the desired feature based on their depth and/or descriptive characteristic continuity. In some embodiments, imaging system 100 may use just the depth values, may use just the descriptive characteristics, or may use a combination of both to identify the first set of data points. Extracting (at 610) the first set of data points may include storing the first set of data points in a new point cloud that excludes all other data points of the first point cloud from which the first set of data points are extracted.

Once the first set of data points of the extracted feature are identified within the first point cloud, imaging system 100 may use the positional data and the descriptive characteristics of the first set of data points to track movement and/or changes to the same feature in the other point clouds, and to efficiently extract a modified second set of data points for the moved or changed feature in the other point clouds. Accordingly, process 600 may include selecting (at 612) a next/second point cloud within the one or more point clouds that represents a next state or next frame of the imaged 3D environment.

Process 600 may include extracting (at 614) the modified second set of data points that form the desired feature within the second point cloud based on the positional data of the second set of data points being within a threshold range of the positional data of the first set of data points and/or satisfying the depth range specified for the desired feature in the user input. In other words, imaging system 100 may locate the second set of data points in the second point cloud based on the data points being having positional commonality or continuity with the first set of data points representing the extracted feature in the first point cloud. Imaging system 100 may transition away from basing the extraction of the feature in the second point cloud off of the user input depth range and/or selection of the first data point in the first point cloud, because the depth range and/or data point positions for the feature may have changed from the first point cloud to the second point cloud.

Process 600 may include modifying (at 616) the selection of the second set of data points based on descriptive characteristic commonality. For instance, imaging system 100 may compare the descriptive characteristics of the second set of data points to the descriptive characteristics of the first set of data points to verify that no extraneous data points or data points of other features are included within the second set of data points, and to further verity that data points of the desired feature were not omitted when extracting (at 614) the modified second set of data points based on the positional data. For instance, imaging system 100 may retain data points within the second set of data points with coloring, luminance, chrominance, and/or other attributes that are within a threshold range of the coloring, luminance, chrominance, and/or other attributes of one or more of the first set of data points that have similar positional data as the retained data points, and may exclude data points from the second set of data points with coloring, luminance, chrominance, and/or other attributes that are not within the threshold range of the coloring, luminance, chrominance, and/or other attributes of similarly positioned data points of the first set of data points. The thresholds allow for some amount of variance in the 3D space positioning of the data points, coloring, and/or lighting (e.g., shadows, highlights, etc.), but prevent data points with entirely new coloring and/or lighting from being included as part of the feature that is extracted from the different point clouds. Additionally, imaging system 100 may use the descriptive characteristics of the first set of data points to add data points to the second set of data points that were not originally included or extracted from the second point cloud because of depth discontinuity with the first set of data points, or because the data points had depth values outside the original user input range. For instance, the desired feature may have moved between the captured state of the first point cloud and the second point cloud such that a subset of data points representing a tip or end of the desired feature in the second point cloud is not in a threshold range of the first set of data points, or the movement may have caused the subset of data points to fall outside the user-defined range for the feature extraction. In such instances, imaging system 100 may identify and add the subset of data points to the second set of data points representing the desired feature in the second point cloud based on the descriptive characteristic continuity of the subset of data points with other data points in the second set of data points and/or with other data points in the first set of data points.

In some embodiments, modifying (at 614) the selection of the second set of data points may include performing an outward search from each particular data point of the second set of data points to ensure that the particular data point has depth continuity and/or descriptive characteristic continuity with each neighboring data point in the second set of data points, to remove data points from the second set of data points that do not have depth continuity and/or descriptive characteristic continuity with other neighboring data points included in the second set of data points, and to add data points that are not included in the second set of data points, but that have depth continuity and/or descriptive characteristic continuity with neighboring data points that are included in the second set of data points.

In some embodiments, process 600 may involve reversing operations 614 and 616 such that the extraction of the second set of data points is initially based on descriptive characteristic commonality or continuity with the first set of data points, and the modification of the second set of data points is based on positional data commonality or continuity. In either case, the resulting similarity of the second set of data points in the second point cloud to the first set of data points in the first point cloud may ensure that the same feature and/or parts of the same feature are extracted from different point clouds even when the feature has moved, coloring or lighting of feature has changed, or the feature has otherwise changed between the point clouds.

Process 600 may select (at 612) a next point cloud and may continue to extract the feature from the next point cloud until there are no additional point clouds or the feature is no longer found in the next point cloud. Imaging system 100 may then perform a collective edit or adjustment to the feature extracted from the different point clouds. Accordingly, process 600 may include applying (at 618) a common set of edits or changes to the different sets of data points that represent the feature at different states or times of the 3D environment. Imaging system 100 may apply (at 618) the common set of edits or changes to the data points representing the extracted feature in the one or more point clouds in order to produce a common look for the feature in the different frames or at the different states of the 3D environment.

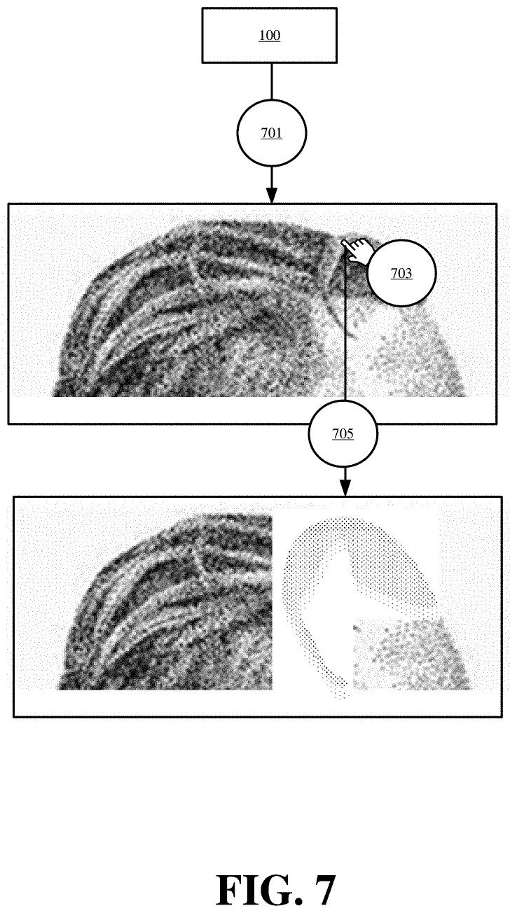

In some embodiments, imaging system 100 may use the positional data and/or characteristic data from the point cloud data points to assist editing, visual effects, and/or other processing of the 3D environment or point cloud. FIG. 7 illustrates an example of assistive point cloud processing in accordance with some embodiments presented herein.

Imaging system 100 may receive and present (at 701) a point cloud representation of an individual's head on a user device. Accordingly, the point cloud may include data points representing the individual's hair. A user may want to edit or adjust the hair, but selection of the hair strands or the collective set of data points representing the hair may be difficult given the size of the hair strands or the number of selections needed.

To assist in the selection of the data points representing the hair, imaging system 100 may receive (at 703) a user selection of one or more data points from a particular cluster of hair in the point cloud. Imaging system 100 may perform the depth-based and characteristic-based feature extraction to automatically detect and select other data points from that particular cluster of hair in the point cloud. Imaging system 100 may enlarge (at 705) the automatically selected data points relative to other data points in the point cloud, and may provide the enlarged view of the set of data points for the particular cluster of hair.

The enlarged subset of the data points may assist the user in better identifying the selection. Additionally, imaging system 100 may update the enlarged subset of data points in real-time based on edits or changes the user applies to those data points. For instance, if the user changes the coloring for the particular cluster of hair, imaging system 100 may update the coloring within the enlarged subset of data points so that the user is better able to visualize the change relative to the rest of the point cloud data points.

Imaging system 100 may return the subset of data points to their original size and position in the point cloud with the corresponding changes in response to the user deselecting the subset of data points or selecting other data points. Imaging system 100 may also resize data points when repositioning an extracted object or feature within a point cloud.

In some embodiments, imaging system 100 may use the point cloud data point depth values for scientific, cartography, engineering, and/or other applications. Specifically, the data point positional data (e.g., x-coordinate, y-coordinate, and z-coordinate) may be defined according to a particular unit of measure or distance (e.g., meters, feet, millimeters, inches, etc.). Imaging system 100 may provide precise measurements between any two data points of a point cloud based on a difference between the positional data of the two data points.

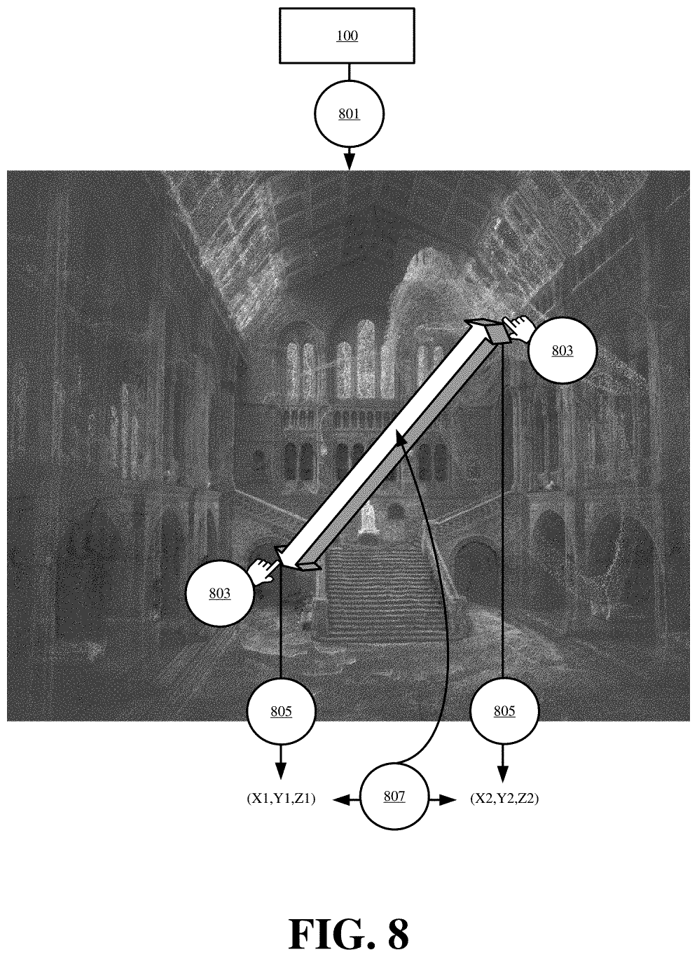

FIG. 8 illustrates an example of generating measurements based on the positional data of different point cloud data points in accordance with some embodiments presented herein. As shown in FIG. 8, imaging system 100 may receive, generate, and/or present (at 801) a point cloud that provides a 3D modeling of a 3D environment. Imaging system 100 may render the point cloud on a user device, and may provide controls that allow a user to freely move within the visual representation of the 3D environment (e.g., the rendering of the point cloud).

The point cloud allows the user to view the 3D environment from positions that may be difficult or otherwise impossible to access in the actual 3D environment. For instance, the point cloud may allow the user to view or select data points within solid walls or within secured or closed rooms.

Imaging system 100 may receive (at 803) and/or detect a user selection of two or more point cloud data points. The user may use a mouse and may click on the two or more point cloud data points, or may provide touch inputs to make the selection.

In response to the selection, imaging system 100 may obtain (at 805) the positional data of each of the two or more selected data points. Imaging system 100 may compute (at 807) a distance between the selected data points based on the difference in the positional data. In some embodiments, imaging system 100 may scale the computed difference to a desired measure. For instance, the positional data stored with each data point may be defined in terms of meters, and imaging system 100 may compute the distance between the data points in meters.

Imaging system 100 may include one or more devices and/or sensors for generating point cloud representations of 3D environments, extracting features and/or objects from the point clouds using the positional data and characteristic data that is generated for the point cloud data points, manipulating the point clouds, extracted features, and/or extracted objects, rendering the original and manipulated point clouds, providing measurements, and/or providing other point cloud applications. The one or more devices and/or sensors may be integrated or separate components running locally and/or remotely within a data network. In some embodiments, imaging system 100 may be integrated as part of or may remotely interface with one or more user devices including tablets, laptop computers, desktop computers, smartphones, visual effects systems, video editing systems, computer-aided design (“CAD”) systems, and/or other devices that render or work with point cloud files.

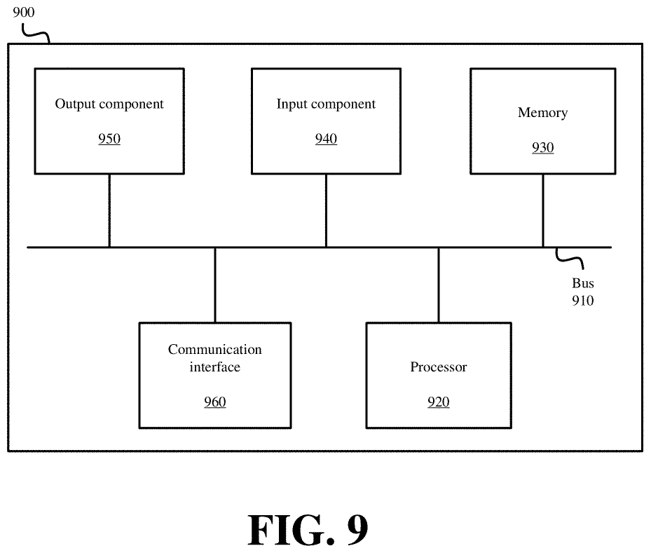

FIG. 9 is a diagram of example components of device 900. Device 900 may be used to implement one or more of the devices or systems described above (e.g., imaging system 100, user device, sensors, etc.). Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, or processing logic that may interpret and execute instructions. Memory 930 may include any type of dynamic storage device that may store information and instructions for execution by processor 920, and/or any type of non-volatile storage device that may store information for use by processor 920.

Input component 940 may include a mechanism that permits an operator to input information to device 900, such as a keyboard, a keypad, a button, a switch, etc. Output component 950 may include a mechanism that outputs information to the operator, such as a display, a speaker, one or more LEDs, etc.

Communication interface 960 may include any transceiver-like mechanism that enables device 900 to communicate with other devices and/or systems. For example, communication interface 960 may include an Ethernet interface, an optical interface, a coaxial interface, or the like. Communication interface 960 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 900 may include more than one communication interface 960. For instance, device 900 may include an optical interface and an Ethernet interface.

Device 900 may perform certain operations relating to one or more processes described above. Device 900 may perform these operations in response to processor 920 executing software instructions stored in a computer-readable medium, such as memory 930. A computer-readable medium may be defined as a non-transitory memory device. A memory device may include space within a single physical memory device or spread across multiple physical memory devices. The software instructions may be read into memory 930 from another computer-readable medium or from another device. The software instructions stored in memory 930 may cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

1. A method comprising:
receiving a first point cloud comprising a plurality of data points that are distributed non-uniformly in three-dimensional (“3D”) space to represent a 3D environment, each data point of the plurality of data points comprising positional data that define a particular position of the data point in the 3D space, and descriptive characteristics that define properties of a surface, a feature, or an object of the 3D environment that is detected at that particular position;
receiving a user selection comprising one or more neighboring data points from the plurality of data points;
obtaining a model of a particular feature that is partly represented by the one or more neighboring data points, wherein the model of the particular feature is formed from a first subset of data points having at least a first range of common descriptive characteristics and a second subset of data points having a different second range of common descriptive characteristics;
selecting at least first, second, and third data points from the plurality of data points that are outside and not included as part of the user selection;
adding the first data point with the one or more neighboring data points from the user selection as a set of data points that represent the particular feature based on (i) the positional data of the first data point being less than a specified distance from the particular position of any one of the one or more neighboring data points in the user selection, and (ii) the descriptive characteristics of the first data point being within the first range of the common descriptive characteristics from the model of the particular feature; and
adding the second data point into the set of data points that represent the particular feature based on the positional data of the second data point being less than the specified distance from the positional data of the first data point or any one of the one or more neighboring data points in the user selection, and (ii) the descriptive characteristics of the second data point being outside the first range of the common descriptive characteristics and within the second range of the common descriptive characteristics from the model of the particular feature;
excluding the third data point from the set of data points that represent the particular feature in response to (i) the positional data of the third data point being more than the specified distance from any data point in the set of data points, or (ii) the descriptive characteristics of the third data points being outside the first and second ranges of the common descriptive characteristics from the model of the particular feature;
extracting the set of data points that represent the particular feature from the first point cloud;
inserting the set of data points into a second point cloud with one or more data points that differ from the plurality of data points of the first point cloud; and
rendering the second point cloud.

2. The method of claim 1 further comprising:
applying at least one visual effect to the particular feature, wherein applying the at least one visual effect comprises adjusting a visual representation of the particular feature by modifying the positional data or the descriptive characteristics of the first set of data points apart from the positional data or the descriptive characteristics of other data points from the plurality of data points of the first point cloud.

3. The method of claim 1 further comprising:
applying at least one visual effect to a background or other surfaces, features, or objects of the 3D environment formed from other data points of the plurality of data points that are not included as part of the set of data points, wherein applying the at least one visual effect comprises altering the background or the other surfaces, features, or objects of the 3D environment by modifying the other data points; and
wherein inserting the set of data points into the second point cloud comprises integrating the first set of data points with a different plurality of data points that results from applying the at least one visual effect to the background or the other surfaces, features, or objects of the 3D environment.

4. (canceled)

5. (canceled)

6. The method of claim 1, wherein receiving the user selection comprises:
rendering the plurality of data points of the first point cloud on a display; and
detecting user input that selects the one or more neighboring data points from the rendering.

7. The method of claim 1 further comprising:
receiving a second selection of a particular region within the first point cloud, wherein the particular region comprises a volume within the 3D space; and
isolating a first group of the plurality of data points based on the positional data of the first group of data points comprising x, y, and z coordinates that are within the particular region; and
filtering the first group of data points to a smaller second group of data points by removing one or more data points from the first group of data points with descriptive characteristics that differ by more than a threshold amount from the descriptive characteristics of the second group of data points.

8. The method of claim 1 further comprising:
manipulating the set of data points after said extraction with at least one visual effect, wherein manipulating the first set of data points comprises changing the set of data points representing the particular feature from having a first shape and form in the 3D environment to having a second shape and form that is different than the first shape and form.

9. The method of claim 1 further comprising:
receiving a third point cloud representing the 3D environment at a different time or state than the first point cloud;
extracting a second set of data points from the third point cloud that have continuity in one or more of the positional data or the descriptive characteristics with the set of data points extracted from the first point cloud; and
retaining at least one visual effect applied to the set of data points across different times or states of the 3D environment by applying the at least one visual effect to the second set of data points extracted from the third point cloud.

10. (canceled)

11. The method of claim 1 further comprising:
enhancing detail or accuracy of the particular feature extracted from the first point cloud by adding a fourth data point from the plurality of data points to the set of data points in response to the descriptive characteristics of the fourth data point being in a range of the descriptive characteristics of at least one data point in the set of data points closest to the third data point.

12. (canceled)

13. A system comprising:
one or more processors configured to:
receive a first point cloud comprising a plurality of data points that are distributed non-uniformly in three-dimensional (“3D”) space to represent a 3D environment, each data point of the plurality of data points comprising positional data that define a particular position of the data point in the 3D space, and descriptive characteristics that define properties of a surface, a feature, or an object of the 3D environment that is detected at that particular position;
receive a user selection comprising one or more neighboring data points from the plurality of data points;
obtain a model of a particular feature that is partly represented by the one or more neighboring data points, wherein the model of the particular feature is formed from a first subset of data points having at least a first range of common descriptive characteristics and a second subset of data points having a different second range of common descriptive characteristics;
select at least first, second, and third data points from the plurality of data points that are outside and not included as part of the user selection;
add the first data point with the one or more neighboring data points from the user selection as a set of data points that represent the particular feature based on (i) the positional data of the first data point being less than a specified distance from the particular position of any one of the one or more neighboring data points in the user selection, and (ii) the descriptive characteristics of the first data point being within the first range of the common descriptive characteristics from the model of the particular feature; and
add the second data point into the first set of data points that represent the particular feature based on the positional data of the second data point being less than the specified distance from the positional data of the first data point or any one of the one or more neighboring data points in the user selection, and (ii) the descriptive characteristics of the second data point being outside the first range of the common descriptive characteristics and within the second range of the common descriptive characteristics from the model of the particular feature;
exclude the third data point from the set of data points that represent the particular feature in response to (i) the positional data of the third data point being more than the specified distance from any data point in the set of data points, or (ii) the descriptive characteristics of the third data points being outside the first and second ranges of the common descriptive characteristics from the model of the particular feature;
extract the set of data points that represent the particular feature from the first point cloud;
insert the first set of data points into a second point cloud with one or more data points that differ from the plurality of data points of the first point cloud; and
render the second point cloud.

14. The system of claim 13, wherein the one or more processors are further configured to:
apply at least one visual effect to the particular feature, wherein applying the at least one visual effect comprises adjusting a visual representation of the particular feature by modifying the positional data or the descriptive characteristics of the first set of data points apart from the positional data or the descriptive characteristics of other data points from the plurality of data points of the first point cloud.

15. The system of claim 13, wherein the one or more processors are further configured to:
apply at least one visual effect to a background or other surfaces, features, or objects of the 3D environment formed from other data points of the plurality of data points that are not included as part of the set of data points, wherein applying the at least one visual effect comprises altering the background or the other surfaces, features, or objects of the 3D environment by modifying the other data points; and
wherein inserting the set of data points into the second point cloud comprises integrating the set of data points with a different plurality of data points that results from applying the at least one visual effect to the background or the other surfaces, features, or objects of the 3D environment.

16. (canceled)

17. (canceled)

18. The system of claim 13, wherein receiving the user selection comprises:
rendering the plurality of data points of the first point cloud on a display; and
detecting user input that selects the one or more neighboring data points from the rendering.

19. The system of claim 13, wherein the one or more processors are further configured to:
enhance detail or accuracy of the particular feature extracted from the first point cloud by adding a fourth data point from the plurality of data points to the first set of data points in response to the descriptive characteristics of the fourth data point being in a range of the descriptive characteristics of at least one data point in the first set of data points closest to the third data point.

20. A non-transitory computer-readable medium, storing a plurality of processor-executable instructions to:
receive a first point cloud comprising a plurality of data points that are distributed non-uniformly in three-dimensional (“3D”) space to represent a 3D environment, each data point of the plurality of data points comprising positional data that define a particular position of the data point in the 3D space, and descriptive characteristics that define properties of a surface, a feature, or an object of the 3D environment that is detected at that particular position;
receive a user selection comprising one or more neighboring data points from the plurality of data points;
obtain a model of a particular feature that is partly represented by the one or more neighboring data points, wherein the model of the particular feature is formed from a first subset of data points having at least a first range of common descriptive characteristics and a second subset of data points having a different second range of common descriptive characteristics;
select at least first, second, and third data points from the plurality of data points that are outside and not included as part of the user selection;
add the first data point with the one or more neighboring data points from the user selection as a set of data points that represent the particular feature based on (i) the positional data of the first data point being less than a specified distance from the particular position of any one of the one or more neighboring data points in the user selection, and (ii) the descriptive characteristics of the first data point being within the first range of the common descriptive characteristics from the model of the particular feature; and
add the second data point into the first set of data points that represent the particular feature based on the positional data of the second data point being less than the specified distance from the positional data of the first data point or any one of the one or more neighboring data points in the user selection, and (ii) the descriptive characteristics of the second data point being outside the first range of the common descriptive characteristics and within the second range of the common descriptive characteristics from the model of the particular feature;
exclude the third data point from the set of data points that represent the particular feature in response to (i) the positional data of the third data point being more than the specified distance from any data point in the set of data points, or (ii) the descriptive characteristics of the third data points being outside the first and second ranges of the common descriptive characteristics from the model of the particular feature;
extract the set of data points that represent the particular feature from the first point cloud;
insert the set of data points into a second point cloud with one or more data points that differ from the plurality of data points of the first point cloud; and
render the second point cloud.

21. The method of claim 1 further comprising:
generating the model for the different sets of descriptive characteristics of the particular feature; and
comparing the descriptive characteristics of the first data point to the model; and
wherein adding the first data point as part of the set of data points comprises:
determining that the descriptive characteristics of the first data point match one or more of the different sets of descriptive characteristics within the model.

22. The method of claim 1 further comprising:
analyzing the descriptive characteristics of the plurality of data points;
modeling different descriptive characteristics across each surface, feature, or object of the 3D environment based on said analyzing; and
generating the model based on modeling the descriptive characteristics of the particular feature across the first range of common descriptive characteristics and the different second range of common descriptive characteristics.

23. The method of claim 1 further comprising:
selecting a fourth data point from the plurality of data points that is outside and not included as part of the user selection; and
adding the fourth data point into the set of data points based on (i) the positional data of the fourth data point being more than the specified distance from the particular position of any data point in the set of data points, and (ii) the descriptive characteristics of the fourth data point being within one of the first range of the common descriptive characteristics or the second range of the common descriptive characteristics from the model of the particular feature.

24. The method of claim 1, wherein extracting the set of data points comprises:
enlarging the set of data points relative to other data points from the plurality of data points in a presentation of the first point cloud;
applying one or more edits to the set of data points while the set of data points are enlarged in the presentation; and
returning the set of data points to a size that matches a size of the other data points after applying the one or more edits.

25. The method of claim 1 further comprising:
receiving a second user selection of the second data point after adding the first and second data points to the set of data points;
modifying the set of data points in response to receiving the second user selection, wherein modifying the set of data points comprises:
removing a first group of data points from the set of data points based on the descriptive characteristics of the first group of data points having commonality with the descriptive characteristics of the second data point, wherein the second data point is removed from the set of data points as part of removing the first group of data points; and
retaining a second group of data points from the set of data points based on the descriptive characteristics of the second group of data points not having commonality with the descriptive characteristics of the second data point.

26. The method of claim 1 further comprising:
receiving a second user selection of the second data point after adding the first and second data points to the set of data points;
modifying the set of data points in response to receiving the second user selection, wherein modifying the set of data points comprises:
removing a first group of data points from the set of data points based on the positional data of the first group of data points forming a pattern with the second data point, wherein the second data point is removed from the set of data points as part of removing the first group of data points; and
retaining a second group of data points from the set of data points based on the positional data of the second group forming a different than the first group of data points.
